(19) United States
(12) Patent Application Publication
(10) Pub. No.: US 2011/0027462 A1
(43) Pub. Date: Feb. 3, 2011

(54) FAST DEPOSITION SYSTEM AND METHOD FOR MASS PRODUCTION OF LARGE-AREA THIN-FILM CIGS SOLAR CELLS

(76) Inventors: Chang Hun Hwang, Gyeonggi-do (KR); Tae Wan Kim, Seoul (KR); Tae Hee Lee, Gyeonggi-do (KR); Sung Soo Kim, Seoul (KR)

Correspondence Address: HISCOCK & BARCLAY, LLP, 2000 HSBC PLAZA, 100 Chestnut Street, ROCHESTER, NY, 14604-2404, US

(21) Appl. No.: 12/615,637

(22) Filed: Nov. 10, 2009

(30) Foreign Application Priority Data
Aug. 3, 2009 (KR) 10-2009-0071407

(51) Int. Cl. B05D 5/12; B05B 7/06

(52) U.S. Cl. 427/74; 118/314

(57) ABSTRACT

Disclosed herein is a fast deposition system and method for mass production of large-area thin-film CIGS solar cells. The fast deposition system includes: a deposition chamber; a plurality of source chambers each coupled at one side thereof to one outer side or both outer sides of the deposition chamber through an opening and closing device, each source chamber including a crucible unit adapted to evaporate a source material; a plurality of effusion nozzle units disposed inside the deposition chamber and detachably engaged with a plurality of crucible units in such a fashion as to fluidically communicate with the crucible units, each of the effusion nozzle units including a plurality of nozzles longitudinally formed at a bottom surface thereof and having an inner space of a predetermined size; and a moving means adapted to forwardly and backwardly move the crucible unit in each of the source chambers.

### CROSS-REFERENCE TO RELATED APPLICATIONS

This application claims priority to Korean Patent Application Number 10-2009-71407 filed Aug. 3, 2009, the contents of which are incorporated by reference.

### FIELD OF THE INVENTION

The present invention relates to a fast deposition system for mass production of large-area thin-film CIGS solar cells, which can massively produce large-area thin-film CIGS solar cells at high speed, and more particularly, to a fast deposition system for mass production of large-area thin-film CIGS solar cells, which includes a thin-film deposition device for enabling a continuous thin film deposition process to improve the thickness uniformity of a thin film formed on a large-area substrate and obtain the optimum component composition ratio while massively producing large-area CIGS solar cells at high speed, and a fast deposition method for mass production of large-area thin-film CIGS solar cells.

### BACKGROUND

Currently, in regard to a solar cell technology, thin-film solar cells are highly spotlighted in which although the conversion efficiency of the solar cell is low in terms of satisfaction of efficiency, lost cost, durability and non-occurrence of other environmental problems, lost manufacturing cost, simple manufacturing process, application of various methods such as adhesion of the solar cell onto a glass window or a curved surface in the form of a thin film, and deposition of the thin films of compound semiconductors (CIGS, CdTe etc.) enabling the scale-up thereof are achieved.

Among these solar cells, a constantly increasing interest is taken in a CIGS thin-film solar cell consisting of four elements, i.e., copper (Cu), indium (In), gallium (Ga) and selenium (Se), which are environmentally friendly and are excellent in terms of efficiency and durability.

In a fabrication process system of such a CIGS thin-film solar cell, a process of forming a CIGS thin film on a substrate is mainly performed by vacuum evaporation, sputtering or the like.

In case where the thin film forming process is performed by the sputtering, the thin film can be formed within a short period of time since the sputtering method ensures a higher thin film formation rate than the vacuum evaporation method. In addition, since the lifespan of source targets is lengthened and the number of supplies is reduced, the waste of the time spent in replacing the source can be prevented. On the contrary, the sputtering method eventually has a shortcoming in that defect occurs and quality is degraded due to a damage occurring on the thin film by selenium (Se) of the source targets as well as in that it reaches a relatively low energy conversion efficiency of approximately 8% or so as compared to the vacuum evaporation method.

Thus, many researches and experiments are in progress on the vacuum evaporation method having a high energy conversion efficiency upon the formation of the CIGS thin film.

The thin film formation process using the vacuum evaporation method has an advantage in that the constituent compounds of a deposited thin film has a good crystal quality and can attain a light-absorbing layer having a maximum energy conversion efficiency of up to 19.9%, but also has a disadvantage in that since the thin film formation is performed in a high-temperature, high-vacuum environment, much time is required to replace thin film sources, thereby resulting in an increase in the tack time and a degradation in economic efficiency for technical efficiency.

Therefore, in order to apply the CIGS thin film formation process to the supply of the alternative energy, there is a need for a deposition process system which employs the vacuum evaporation method as well as can maximally increase the conversion efficiency of less than 10% of the CIGS thin-film solar cell at present, can deposit CIGS thin film sources on a large-area substrate to a certain thickness in a uniform composition ratio, and can mass-product large-area thin-film CIGS solar cells at high speed.

Furthermore, in order to massively product large-area solar cells at high speed, it is required that each source component of Cu(In,Ga)Se₂ should be uniformly deposited on a substrate while being maintained in a proper composition ratio in the deposition process. In addition, the supply of each CIGS source depleted should be easily achieved.

However, a conventional vacuum evaporation system has a construction in which a high-temperature evaporation source including source materials to be deposited is disposed in a high-temperature, high-vacuum chamber where the deposition process is performed.

U.S. Pat. No. 6,310,281 discloses high-vacuum deposition methods employing three to five boats as effusion source for elements to be deposited. Here, each point on a substrate material first passes directly over a copper source, thereafter over a gallium source, thereafter over an indium source, and throughout, over the selenium sources. In this case, the component composition ratio of the CIGS thin film deposited on the substrate varies depending on the deposition zone.

In addition, Korean Patent Laid-Open Publication No. 2008-95127 to OLEDON Technology Inc. discloses a top-down type high-temperature evaporation source for deposition of a metal thin film on a substrate, which includes various kinds of elements to be sprayed onto and deposited on the substrate disposed at a lower portion. Besides, apparatuses and methods for depositing the thin film by separating the elements by each source have been proposed in many domestic and foreign patent laid-open and registration gazettes.

However, such a conventional deposition apparatus entails a problem in that since evaporation sources provided by each source material is constructed to supply source materials to points on the substrate, each point of the substrate encounters a copper-rich region or a copper-poor region, a gallium/indium-rich region or a gallium/indium-poor region, and the like, so that the thickness and composition of the CIGS layer deposited on the substrate are non-uniform and it is impossible to attain the growth of a crystal whose particle size is large.

Moreover, a plurality of evaporation sources should be installed in order to deposit the CIGS thin film on a large-area substrate in a uniform composition ratio using the evaporation sources which can supply source materials to each point on the substrate, the installation cost increases. Further, the conventional deposition apparatus encounters a drawback in that since the vaporization temperature of evaporation sources installed in plural numbers in a high-temperature vacuum chamber should be controlled individually, the quantity of electricity concentrated increases, which leads to increased power consumption, and the maintenance and repair of the each evaporation source is difficult. In addition, there occurs a problem in that since a plurality of evaporation sources is disposed in the deposition chamber, the deposited thin film contains impurities through outgassing due to high vacuum.

Also, Korean Patent Laid-Open Publication No. 2009-15324 to OLEDON Technology Inc. discloses a linear top-down type high-temperature evaporation source for deposition of a metal thin film on a substrate, which includes elements to be sprayed onto and deposited on the substrate disposed at a lower portion.

However, such a conventional deposition apparatus entails a problem in that since evaporation sources are installed in plural numbers in a high-temperature vacuum chamber, the maintenance and repair of the each evaporation source is difficult. In addition, the conventional deposition apparatus encounters a drawback in that the vaporization temperature of each evaporation source installed in the high-temperature vacuum chamber should be controlled individually, as well as the evaporated sources are condensed onto the nozzle wall surfaces due to a temperature difference between a relatively long nozzles and a linear top-down crucible being heated. Moreover, there still occurs a problem in that since a plurality of evaporation sources is disposed in the deposition chamber, the deposited thin film contains impurities through outgassing due to high vacuum.

Further, Korean Patent Laid-Open Publication No. 2009-43245 discloses a fabrication method of a CIGS thin film using a vacuum sputtering method in which CuIn, CuGa and a selenide compound are deposited on a substrate to form a precursor which is in turn subjected to heat treatment.

However, in case where the CIGS thin film is fabricated by the vacuum sputtering method, an ultimate conversion efficiency is not high enough for commercialization as well as a precursor formation and heat-treatment step should be performed, which causes a problem in mass-production of the CIGS thin film.

In an attempt to solve the above problem, as one example of the evaporation source, Korean Patent Laid-Open Publication No. 2008-97505 teaches an apparatus for depositing a thin film, which is provided with a shower head type gas injection unit including: a body having a certain inner space formed therein and a plurality of through-holes formed at a lower portion thereof; and a deposition source supply section mounted at the outside of a deposition chamber and connected to an upper portion of the body so as to supply deposition materials to the inside of the body.

However, the gas injection unit of the Korean Patent Laid-Open Publication No. 2008-97505 can be constructed in a low-temperature, low-vacuum environment, but cannot be applied to a deposition system requiring a high-temperature, high-vacuum environment such as in the CIGS thin film deposition. The reason for this is that when the body is heated to vaporize the evaporation source materials, it is impossible to control the opening and closing of a supply channel for interconnecting the body and the deposition source supply section using a typical method.

In addition, in such a conventional thin film deposition process system, in order to re-fill the evaporation source materials depleted as the deposition progresses, it is required that the operation of the process system should be first stopped, the high vacuum should be released from a deposition chamber, the evaporation sources of a crucible should be re-filled with a new source material after lowering a high-temperature, and the temperature and the degree of vacuum of the deposition chamber should be again made high to resume the deposition process. There is caused a problem in that since this process of re-filing the evaporation source materials requires a total time period of approximately six months, a 24-hour deposition continuous process is impossible.

Further, Korean Patent Laid-Open Publication No. 2006-35308 filed by Chang-Hun Hwang teaches a continuous supply apparatus of an evaporation source for an OLED deposition process, in which an organic material effusion unit, an organic material guide tube and a crucible are connected with one another so that an organic gaseous material evaporated in the crucible is induced to be deposited on a substrate via the organic material guide tube and the organic material effusion unit, and in which the evaporation source including the crucible is removed from the organic material guide tube upon the depletion of the organic material in the crucible and then a gate valve is shut off so that the organic material can be re-filled into the crucible in a state where the deposition chamber is maintained in a vacuum-tight state.

However, the organic material effusion unit of the above Korean Patent Laid-Open Publication No. 2006-35308 is disposed below the substrate and is provided to serve as a point source. In a high-temperature, high-vacuum large-area CIGS thin film deposition system, disadvantageously a large-area substrate disposed at an inner upper portion of the deposition chamber sags downwardly. In addition, there occurs a problem in that due to the point source each point of the substrate encounters a copper-rich region or a copper-poor region, a gallium/indium-rich region or a gallium/indium-poor region, and the like, so that the smoothness of the substrate is remarkably degraded, the thickness and composition of the CIGS layer deposited on the substrate are non-uniform, and it is impossible to attain the growth of a crystal whose particle size is large.

Moreover, such a conventional thin film deposition process system entails a problem in that in order to re-fill the evaporation source materials depleted as the deposition progresses, it is required that the operation of the process system should be first stopped, the high vacuum should be released from a deposition chamber, the evaporation sources of a crucible should be re-filled with a new source material after lowering a high-temperature, and the temperature and the degree of vacuum of the deposition chamber should be again made high to resume the deposition process, so that a 24-hour continuous process is impossible.

Further, such a conventional thin film deposition process system encounters a drawback in that it causes the thickness and composition of the deposited CIGS layer to be non-uniform, thereby resulting in contribution to reduced convention efficiency. Furthermore, the time spent to re-fill the depleted evaporation source materials brings about a considerable reduction in production efficiency for cost competitiveness.

### SUMMARY OF THE INVENTION

Therefore, the present invention has been made to solve the above-mentioned problems occurring in the prior arts, and it is a first object of the present invention to provide a fast deposition system for mass production of large-area thin-film CIGS solar cells, in which a CIGS layer can be deposited on a large-area substrate such that its thickness and composition are uniform.

A second object of the present invention is to provide a fast deposition system for mass production of large-area thin-film CIGS solar cells, in which the deposition process is completed while a large-area substrate is moved along a rail in a deposition chamber without any separate time waste so as to reduce the tack time in a large-area thin-film solar cell process system, so that the solar cells can be massively produced at high speed.

A third object of the present invention is to provide a fast deposition system for mass production of large-area thin-film CIGS solar cells, in which the source materials depleted can be re-filled into the crucible in a state where a deposition chamber is maintained in a high-vacuum state in a large-area thin-film solar cell process system, making it possible to perform a continuous process, and as a consequence solar cells can be mass-produced continuously at high speed.

In order to accomplish the above object, according to one exemplary embodiment of the present invention, there is provided a fast deposition system for mass production of large-area thin-film CIGS solar cells.

The fast deposition system includes:

a deposition chamber;

a plurality of source chambers each coupled at one side thereof to one outer side or both outer sides of the deposition chamber through an opening and closing device, each source chamber including a crucible unit adapted to evaporate a source material;

a plurality of effusion nozzle units disposed inside the deposition chamber and detachably engaged with a plurality of crucible units in such a fashion as to fluidically communicate with the crucible units, each of the effusion nozzle units including a plurality of nozzles longitudinally formed at a bottom surface thereof and having an inner space of a predetermined size; and a moving means adapted to forwardly and backwardly move the crucible unit in each of the source chambers.

Preferably, the crucible unit may include a cylindrical or polygonal box-like body which is opened at a top thereof and is closed at a bottom thereof, and a cover, the cover having a hole formed at one side thereof, or the body having a hole formed at one side of an upper portion thereof and the cover having a hole formed at one side thereof to correspond to the one side of the body.

Also, preferably, the hole formed in the crucible unit may have a female thread formed on the inner circumferential surface thereof.

Also, preferably, each of the source chambers may further include an injector fixedly coupled to each crucible unit in such a fashion as to fluidically communicate with the crucible unit.

Also, preferably, the injector may have a protrusion formed at a front end and a rear end thereof, respectively.

Also, preferably, the protrusion formed at the front end of the injector may have a male thread formed on the outer circumferential surface thereof.

Also, preferably, the protrusion formed at the front end of the injector may have a retaining step formed on the outer circumferential edge thereof.

Also, preferably, the plurality of the effusion nozzle units may be formed in a bar shape having a polygonal cross-section, and has an engagement groove formed at one end thereof in such a fashion as to fluidically communicate with the plurality of source chambers, or formed at both ends thereof.

Also, preferably, the fast deposition system may further include a shutter disposed below the plurality of effusion nozzle units in such a fashion as to be spaced apart from the effusion nozzle units.

Also, preferably, the moving means may include: a movable plate on which the crucible unit is seated, a guide rail adapted to guide the movement of the movable plate, and a movement control device adapted to control the movable plate to be forwardly and backwardly moved.

Also, preferably, the movement control device includes: a bellows-type elastic member disposed at an outer lower portion of the source chamber; a linkage rod adapted to interconnect the movable plate and the bellows-type elastic member; and a controller adapted to control the operation of the linkage rod.

Also, preferably, the movement control device includes a push and pull feedthrough device.

Also, preferably, a deposition section having a construction in which the number of the source chambers is four, the number of the opening and closing devices is four and the number of the effusion nozzle units is four, which constitute one set, is included in plural numbers in a single deposition chamber.

Also, preferably, one of the plurality of deposition sections may be operated such that corresponding opening and closing devices are opened to open the source chambers and the deposition chamber so as to allow the crucible units of the source chambers and the effusion nozzle units of the deposition chamber to be engaged with each other in such a fashion as to fluidically communicate with each other so that the evaporation source materials in the source chambers are deposited on the substrate through the effusion nozzle units in the deposition chamber. The other of the plurality of deposition sections may be operated such that the crucible units of the source chambers and the effusion nozzle units of the deposition chamber are disengaged from each other and the corresponding opening and closing devices are shut off to sealingly close the source chambers and the deposition chamber so that the source materials depleted in the source chambers are re-filled in a state where the deposition chamber is maintained in a vacuum-tight state.

Also, preferably, the deposition chamber including the deposition section in plural numbers may be disposed in plural numbers in a series or parallel relationship.

Also, preferably, the plurality of deposition chambers disposed in series with each other may be constructed such that the total thickness of the CIGS deposition layers to be deposited on the substrate is set in such a fashion that the deposition contents of the CIGS deposition layers are divided in the same ratio or in a predetermined ratio.

Also, preferably, a heating member may be provided at the outer side of each of the crucible units of the plurality of source chambers and at the outer side of each of the plurality of effusion nozzle units, and a housing may be provided at the outer side of the heating member.

Also, preferably, a heat radiation plate may further be provided between the outer side of the heating member and the inner side of the housing.

According to another exemplary embodiment of the present invention, there is provided a fast deposition system for mass production of large-area thin-film CIGS solar cells.

The fast deposition system includes:

a deposition chamber;

a plurality of source chambers each coupled at one side thereof to one outer side or both outer sides of the deposition chamber through an opening and closing device, each source chamber including a crucible unit adapted to evaporate a source material, an injector detachably fixedly coupled to the crucible unit in such a fashion as to fluidically communicate with the crucible unit, and a moving means adapted to forwardly and backwardly move the crucible unit; and

a plurality of effusion nozzle units disposed inside the deposition chamber and each formed in a bar shape having a polygonal cross-section and an inner space of a predetermined size, each effusion nozzle unit having an engagement groove formed at one end or both ends thereof so as to be detachably engaged with the injector in such a fashion as to fluidically communicate with the crucible unit, and a plurality of nozzles longitudinally formed at a bottom surface thereof.

According to yet another exemplary embodiment of the present invention, there is provided a fast deposition method for mass production of large-area thin-film CIGS solar cells.

The fast deposition method includes the steps of:

allowing a plurality of source chambers each including a crucible unit built therein to be respectively connected to one outer side or both outer sides of a deposition chamber including a plurality of effusion nozzle units built therein by means of a plurality of opening and closing devices;

allowing granular metal source materials to be charged in proper amounts into respective crucible units of the plurality of source chambers in the deposition section, closing the covers of the crucible units, fixedly engaging each injector with each of the crucible units, and placing each crucible unit on a moveable plate;

allowing the source chambers to be maintained in a high-vacuum state;

opening the respective opening and closing devices interconnecting the plurality of source chambers and the deposition chamber, and forwardly moving each crucible unit by using a moving means to cause the rear end of the injector to be slidably engaged with an engagement groove of each effusion nozzle unit;

supplying the electric power to heating members surrounding the crucible unit and the effusion nozzle unit to heat the crucible unit and the effusion nozzle unit.

allowing the metal source material stored in the heated crucible unit to be evaporated to form an evaporated source material and allowing the evaporated source material to be diffusedly moved to the effusion nozzle unit along the injector; and

allowing the evaporated source material diffusedly moved to the effusion nozzle unit to be effused downwardly through a plurality of nozzles and to be deposited on the substrate transferred to the inner lower portion of the deposition chamber.

Preferably, one of the plurality of deposition sections may be operated such that corresponding opening and closing devices are opened to open the source chambers and the deposition chamber so as to allow the crucible units of the source chambers and the effusion nozzle units of the deposition chamber to be engaged with each other in such a fashion as to fluidically communicate with each other so that the evaporation source materials in the source chambers are deposited on the substrate through the effusion nozzle units in the deposition chamber. The other of the plurality of deposition sections may be operated such that the crucible units of the source chambers and the effusion nozzle units of the deposition chamber are disengaged from each other and the corresponding opening and closing devices are shut off to sealingly close the source chambers and the deposition chamber so that the source materials depleted in the source chambers are re-filled in a state where the deposition chamber is maintained in a vacuum-tight state, thereby enabling a continuous deposition process.

Also, preferably, the deposition chamber including the deposition section in plural numbers may be disposed in plural numbers in a series or parallel relationship.

Also, preferably, the plurality of deposition chambers disposed in series with each other may be constructed such that the total thickness of the CIGS deposition layers to be deposited on the substrate is set in such a fashion that the deposition contents of the CIGS deposition layers are divided in the same ratio or in a predetermined ratio.

Also, preferably, the plurality of deposition chambers disposed in parallel with each other may be constructed such that any one of the deposition chambers is selected to perform a continuous deposition process.

### BRIEF DESCRIPTION OF THE DRAWINGS

Further objects and advantages of the invention can be more fully understood from the following detailed description taken in conjunction with the accompanying drawings in which:

FIG. 1 is a schematic top plan view illustrating a fast deposition system for mass production of large-area thin-film CIGS solar cells according to a first embodiment of the present invention;

FIG. 2 is a schematic view illustrating the engagement between one of source chambers of FIG. 1 and a deposition chamber;

FIG. 3 is a detailed cross-sectional view illustrating the operation state of the fast deposition system for mass production of large-area thin-film CIGS solar cells of FIG. 2;

FIG. 4 is an exploded perspective view illustrating the engagement between a crucible unit and an injector according to the present invention;

FIGS. 5(a) and 5(b) are views illustrating various arrangements of selenium source chamber among source chambers and effusion nozzle units which fluidically communicate with one another in the fast deposition system for mass production of large-area thin-film CIGS solar cell of FIG. 1;

FIG. 6 is a schematic top plan view illustrating a fast deposition system for mass production of large-area thin-film CIGS solar cells according to a second embodiment of the present invention;

FIG. 7 is a schematic view illustrating the engagement between one of source chambers of FIG. 6 and a deposition chamber;

FIG. 8 is a schematic view illustrating a deposition chamber unit including a plurality of deposition sections provided in a deposition chamber; and

FIGS. 9 and 10 are block diagrams illustrating a state in which a plurality of deposition chamber units including a plurality of deposition sections is arranged in series or in parallel with one another.

### DETAILED DESCRIPTION

The preferred embodiments of the invention will be hereinafter described in more detail with reference to the accompanying drawings.

Embodiments of the present invention will be described in more detail hereinafter with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and sizes of respective elements may be exaggerated for clarity.

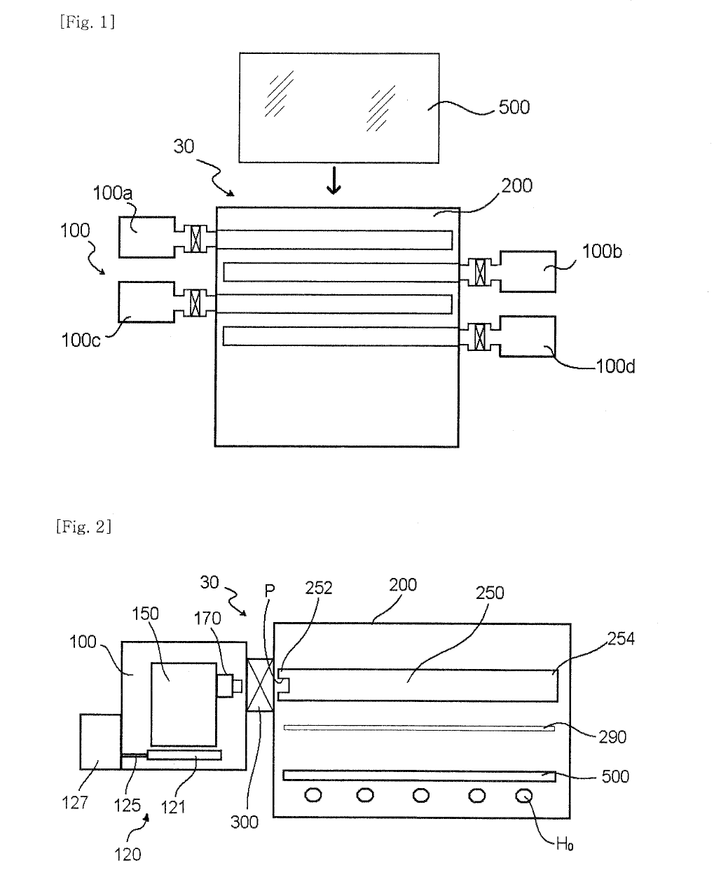

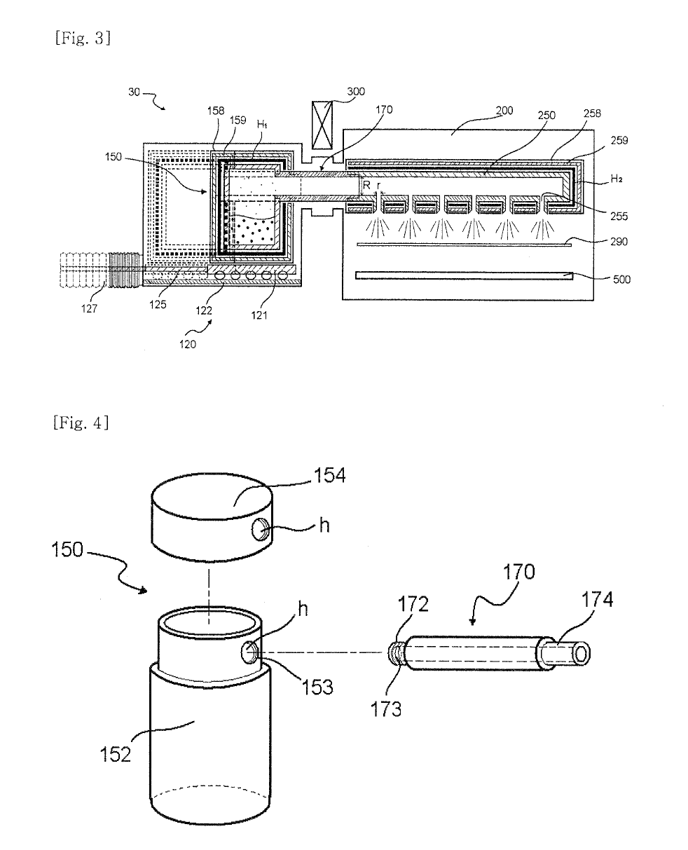

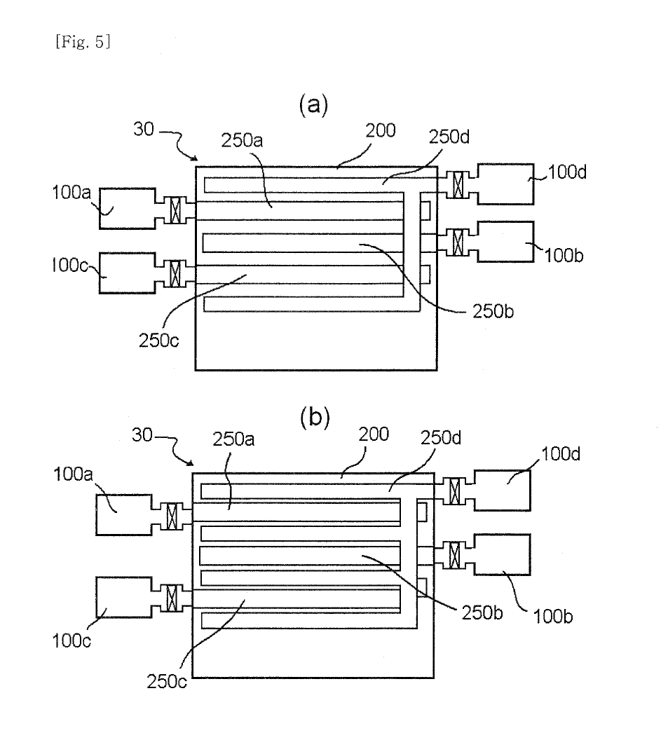

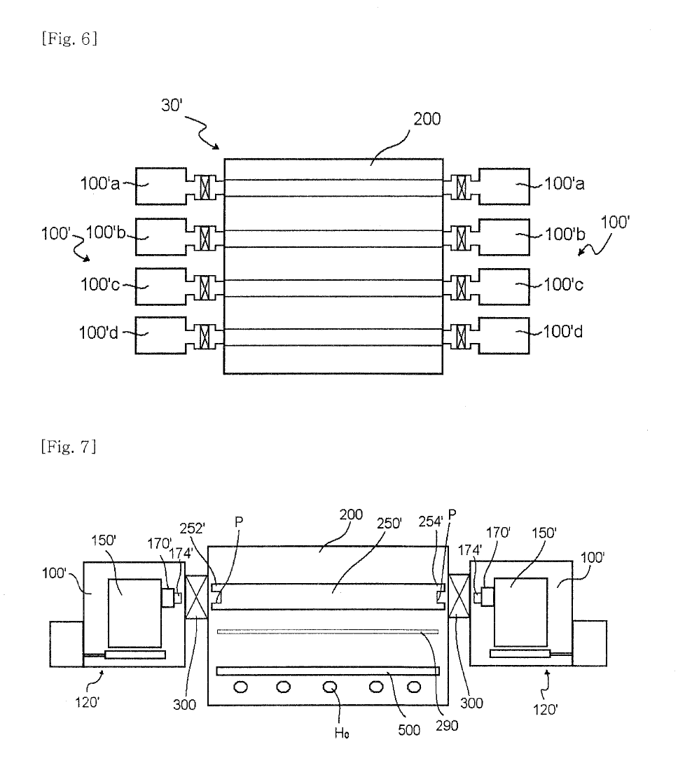

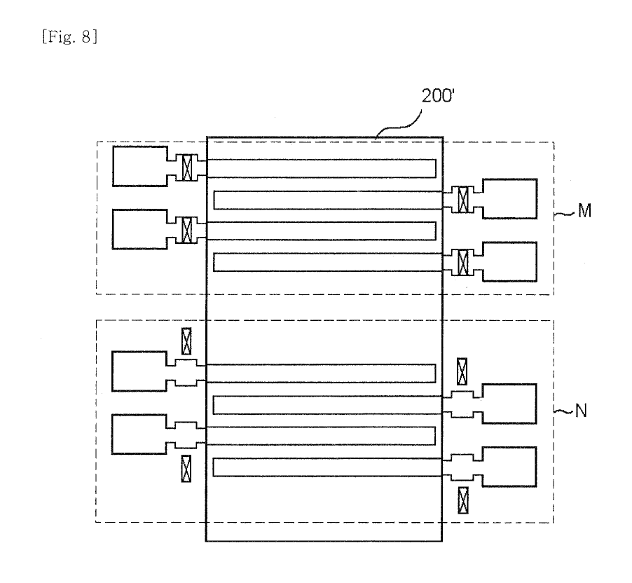

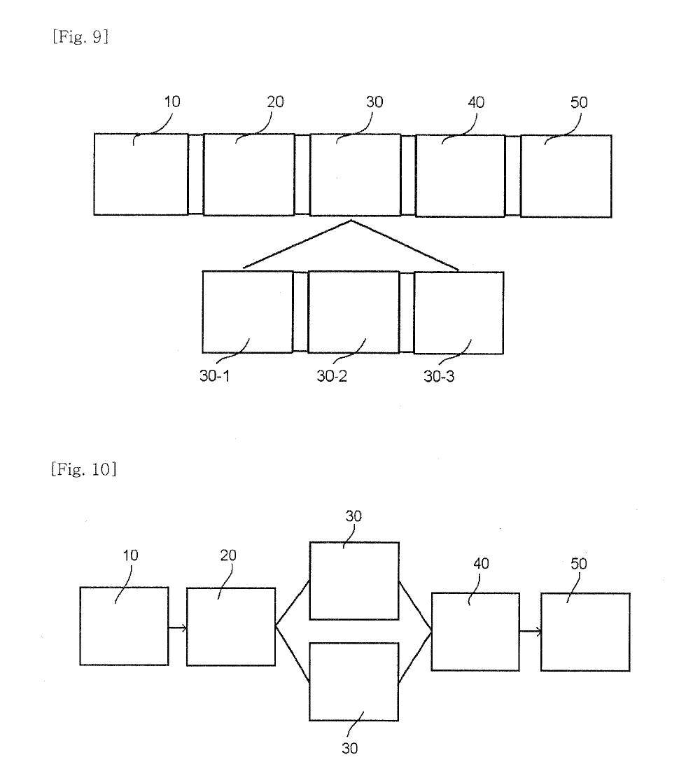

FIG. 1 is a schematic top plan view illustrating a fast deposition system for mass production of large-area thin-film CIGS solar cells according to a first embodiment of the present invention, FIG. 2 is a schematic view illustrating the engagement between one of source chambers of FIG. 1 and a deposition chamber, FIG. 3 is a detailed cross-sectional view illustrating the operation state of the fast deposition system for mass production of large-area thin-film CIGS solar cells of FIG. 2, FIG. 4 is an exploded perspective view illustrating the engagement between a crucible unit and an injector according to the present invention, FIGS. 5 (a) and 5(b) are views illustrating various arrangements of source chambers and effusion nozzle units which fluidically communicate with one another in the fast deposition system for mass production of large-area thin-film CIGS solar cell of FIG. 1, FIG. 6 is a schematic top plan view illustrating a fast deposition system for mass production of large-area thin-film CIGS solar cells according to a second embodiment of the present invention, FIG. 7 is a schematic view illustrating the engagement between one of source chambers of FIG. 6 and a deposition chamber, FIG. 8 is a schematic view illustrating a deposition chamber unit including a plurality of deposition sections provided in a deposition chamber; and FIGS. 9 and 10 are block diagrams illustrating a state in which a plurality of deposition chamber units including a plurality of deposition sections is arranged in series or in parallel with one another.

As shown in FIGS. 9 and 10, in a system for mass-production of a thin film solar cell which includes a typical loading chamber unit 10, a pre-heating chamber unit 20 associated with the loading chamber unit 10 for pre-heating a substrate, a deposition chamber unit 30 associated with the pre-heating chamber unit for depositing source materials on the substrate, a cooling chamber unit 40 associated with the deposition chamber unit for cooling the deposited substrate, and an unloading chamber unit 50 associated with the cooling chamber unit for unloading the cooled substrate, a fast deposition system for mass production of large-area thin-film CIGS solar cells according to the present invention is characterized by the construction of the deposition chamber unit 30.

Here, the substrate is sequentially transferred to each chamber unit along a process line, and an opening and closing device (not shown) is mounted at the front, rear and side portions of each chamber unit along the process line. The loading chamber unit 10, the pre-heating chamber unit 20, the cooling chamber unit 40 and the unloading chamber unit 50 are typical units, and thus detailed description thereof will be omitted to avoid redundancy.

FIGS. 1 to 5 show a first embodiment of the deposition chamber unit 30 constructed as the fast deposition system for mass production of large-area thin-film CIGS solar cells according to the present invention. The deposition chamber unit 30 according to this embodiment includes a deposition chamber 200; a plurality of source chambers 100; a plurality of effusion nozzle units 250; and a moving means 120. Of course, a heating member H₀ is disposed at an inner lower portion of the deposition chamber 200 and the substrate 500 is transferred along a rail above the heating member H₀.

The deposition chamber 200 is a typical deposition chamber, and a plurality of opening and closing devices 300 is mounted at one side or both sides of the deposition chamber 200 in a vertical direction to a process line along which the substrate is transferred among the outer surfaces of the deposition chamber 200. The opening and closing device is a typical gate valve, and the deposition chamber 200 is connected with a plurality of source chambers 100; 100a, 100b, 100e and 100d, which will be described later, in such a fashion as to fluidically communicate with the source chambers through the plurality of opening and closing device 300.

In this case, the plurality of source chamber 100; 100a, 100b, 100c and 100d may be disposed at only one outer side or at only an outer upper portion of the deposition chamber 200, but as shown in FIG. 1, is preferably disposed at both sides of the deposition chamber 200 in an alternating staggered arrangement in terms of space utilization.

The source chamber 100 is coupled at one side thereof to the deposition chamber 200 in such a fashion as to fluidically communicate with the deposition chamber 200 through the opening and closing devices 300. The source chamber 100 includes a crucible unit 150 built therein so as to evaporate source materials. The source chamber further includes an injector 170 fixedly coupled to the crucible unit 150 in such a fashion as to fluidically communicate with the crucible unit.

The crucible unit 150 is disposed in each of the plurality of source chamber 100; 100a, 100b, 100c and 100d so as to evaporate source materials. The crucible unit 150 includes a cylindrical or polygonal box-like body 152 which is opened at a top thereof and is closed at a bottom thereof, and a cover 154. A hole h is formed at one side of the cover 154, or is formed at one side of an upper portion of the body 152 and at one side of the cover 154 to correspond to the one side the upper portion of the body (see FIG. 4).

A front end of the injector 170 is screwably engaged with the hole h. The hole h preferably has a female thread 153 formed on the inner circumferential surface thereof. The female thread is formed to prevent the crucible unit 150 and the injector 170 from being separated from each other and closely fixedly couple them to each other.

In addition, preferably, a nozzle (not shown) is further provided at the inside of the hole h so as to allow an evaporation source material contained in the body 152 to be easily diffused through the injector 170.

In the present invention, although it has been shown that the body 152 and the cover 154 of the crucible unit 150 are constructed to be separated from each other and the cover 154 is press-fit onto the upper portion of the body 152, but the present invention is not limited thereto. Of course, the body 152 and the cover 154 of the crucible unit 150 may be integrally formed with each other, or a female thread and a male thread may be respectively formed on the inner circumferential surface of a lower portion of a separate cover 154 and the outer circumferential surface of an upper portion of the body 152 so that the cover 154 and the body can be detachably threadably engaged with each other.

Also, the crucible unit 150 is preferably disposed inside a housing 158 so as to facilitate maintenance and repair thereof. A heating member H₁ is provided between the outer side of the crucible unit 150 and the inner side of the housing 158 so as to surround the crucible unit 150. A heat radiation plate 159 or a heat radiation wall (not shown) is preferably provided between the outer side of the heating member H₁ and the inner side of the housing 158.

Here, the heating member H₁ serves to heat an evaporation source material contained in the crucible unit 150 to evaporate the source material. The heating member H₁ is preferably provided at the outer side of the cover 154 as well as the body 152 of the crucible. If the temperature of the cover 154 is lowered, the evaporated source materials are condensed on the inner surface of the cover so that an ultimate deposition rate on the substrate 500 is reduced.

When the heating member H₁ is heated by electric power applied thereto to radiate infrared rays, the crucible body is concentratedly heated by the radiated infrared rays so that metal source materials stored in the crucible body are melt to evaporate.

The temperature of the heating member of each crucible unit is controlled to conform to each source material by each temperature control sensor (not shown). Typically, the heating temperatures of a plurality of crucible units 150 having a copper source, a gallium source, an indium source and a selenium source stored therein are set such that the heating temperature for the cooper source ranges from approximately 1500□ to 1600□, the heating temperatures for the gallium source and the indium source range from approximately 1200□ to 1300□, and the heating temperature for the selenium source ranges from approximately 400□.

The heat radiation plate 159 is intended to allow the infrared rays radiated from the heating member H₁ to be concentrated onto the crucible unit 150. The heat radiation plate 159 serves to reflect the infrared rays emitted from the heating member H₁ and the crucible unit to induce the crucible unit 150 to be heated up to a maximum temperature of 2000□. The material of the heat radiation plate is preferably graphite or ceramic material having a high temperature endurance, but is, of course, not limited thereto.

The injector 170 is detachably engaged with the hole h formed at one side of the crucible unit 150. The injector 170 has a cylindrical or polygonal shape which is opened at both ends thereof, and has protrusions 172 and 174 formed at the front and rear ends thereof. Each of the protrusion 172 and 174 has a step formed thereon. The protrusion 172 formed at the front end of the injection 172 is engaged with the hole h of the crucible unit 150, and the protrusion 174 formed at the rear end of the injector 172 is fittingly engaged with an engagement groove P of the effusion nozzle unit 250, which will be described later.

Similarly, the protrusion 172 formed at the front end of the injector 170 also has a male thread 173 formed on the outer circumferential surface thereof so as to be screwably engaged with a female thread 153 formed on the inner circumference surface of the hole h or the protrusion 172 has a retaining step (not shown) formed on the outer circumferential edge thereof, so that the injector 170 and the crucible unit 150 are prevented from being easily separated from each other. Thus, the screwable engagement of the male thread 173 and the female thread 153 and the engagement between the retaining step and the hole h of the crucible unit prevent the injector 170 from being easily separated from the cubicle unit 150 upon the forward and backward movement of the crucible unit 150.

In addition, the protrusion 174 formed at the rear end of the injector 170 is preferably fittingly engaged with the engagement groove P of the effusion nozzle unit 250 which will be described later in such a fashion as to be slidably moved forwardly and backwardly. Here, various sealing materials (not shown) may be further provided between the end edge of the protrusion 174 and the engagement groove P so as to hermetically seal the coupling portion between the injector 170 and the effusion nozzle unit 250.

The plurality of the effusion nozzle units 250 is formed in a bar shape having a polygonal cross-section and an inner space of a predetermined size. One end 252 of each effusion nozzle unit 250 is opened so as to fluidically communicate with each associated source chamber, and an engagement groove P is formed at the inner circumferential edge of the one end 252 of the each effusion nozzle unit 250. Each effusion nozzle unit 250 includes a plurality of nozzles 255 longitudinally formed at a bottom surface thereof.

In addition, the plurality of effusion nozzle units 250 is fixedly mounted at an upper portion of the deposition chamber 200 in a vertical direction to a process line. The one ends 252 of the plurality of effusion nozzle units 250 are arranged so as to respectively correspond to the plurality of opening and closing devices 300 mounted at one side or both sides of the deposition chamber 200.

Further, the shape of the nozzle 255 includes, but is not limited to, a cylindrical shape, a funnel shape, a sandglass shape and the like. The nozzles 255 are designed such that the evaporated source materials in the effusion nozzle units 250 are effused or injected downwardly smoothly. Also, the nozzle 255 is preferably formed in a funnel- or sandglass-shape in order for the effused source materials to be evenly deposited on the substrate 500.

Here, the sum (S=S₁+S₁+ . . . +Sₙ) of the cross-section (Sₙ; n is an integer greater than 0) of the inner diameter (r) of each of the plurality of nozzles 255 of the effusion nozzle unit 250 preferably is smaller than the cross-section (A) of the inner diameter (R) of the rear end protrusion 174 of the injector 170 (i.e., S<A).

This is aimed to allow the amount of the evaporated source material effused downwardly from each nozzle 255 of the effusion nozzle unit 250 onto the substrate to be made uniform and constant. That is, if the cross-section S is greater than the cross-section A, a nozzle of the effusion nozzle unit 250 at a position adjacent to the rear end of the injector 170 effuses a larger amount of the evaporated source material downwardly. Moreover, as it goes toward the front end of the injector 170, the amount of the evaporated source material effused downwardly from a corresponding nozzle of the effusion nozzle unit 250 is remarkably reduced. Consequently, a uniform thin film is not entirely deposited on a large-area substrate.

Moreover, a heating member H₂ is preferably provided at the outer side of the effusion nozzle unit 250 so as to prevent the evaporated source materials in the effusion nozzle unit 250 from being condensed or adhered onto the inner wall surface of the effusion nozzle unit as well as enable the smooth downward effusion of the evaporated source materials. Here, preferably, the heating temperature of the heating member H₂ ranges from approximately 1200□ to 1300□. This heating temperature range is a temperature range for preventing condensation of the copper evaporation source requiring high temperature upon the vaporization of the copper evaporation source.

Similarly, a heat radiation plate 259 or a heat insulating wall (now shown) is preferably provided at the outer side of the heating member H₂ so as to allow the infrared rays radiated from the heating member H₂ to be concentrated to the effusion nozzle unit 250. Also, a housing 258 is provided at the outer side of the heat radiation plate 259 so as to cover the surroundings of the heat radiation plate to prevent heat radiation out of the heat radiation plate and facilitate the maintenance and repair of the effusion nozzle unit 250. A cooling line (not shown) is preferably further provided at the outer side of the housing 258 so as to prevent the emission of the radiant heat into the deposition chamber 200.

In addition, preferably, the deposition chamber unit 30 further includes a shutter 290 between the effusion nozzle unit 250 and the substrate 500 in the deposition chamber 200. The shutter 290 is intended to prevent deposition of impurities on the substrate prior to deposition of the evaporated source materials onto the substrate. When the source chamber associated with the effusion nozzle unit 250 is being filled with new source materials, the shutter 290 is shut off so as to isolate the effusion nozzle unit and the substrate from each other. During the deposition of the source materials, the shutter 290 is opened so as to control the evaporated source materials to be properly effused from the effusion nozzle unit 250 to the substrate.

The moving means 120 serves to forwardly and backwardly move the crucible unit 150 in the source chamber 100. The moving means 120 includes a movable plate 121 on which the crucible unit 150 is seated, a guide rail 122 for guiding the movement of the movable plate 121, and a movement control device 127 for controlling the movable plate 121 to be forwardly and backwardly moved.

The guide rail 122 serves to allow the movable plate 121 to be forwardly and backwardly moved along a predetermined course. The guide rail 122 is operated at a position where the injector 170 coupled to the crucible unit 150 is precisely engaged with and disengaged from the effusion nozzle unit 250 through the opening and closing device 300, and enables a slidable engagement and disengagement between the injector 170 and the effusion nozzle unit 250.

In addition, the movement control device 127 includes a bellows-type elastic member disposed at an outer lower portion of the source chamber 100, a linkage rod 125 for interconnecting the movable plate 121 and the bellows-type elastic member, and a controller (not shown) for controlling the operation of the linkage rod. The bellows-type elastic member is employed to enable the smooth forwardly and backwardly movement of the movable plate 121. It will be apparent to those skilled in the art that the present invention is not limited to the bellows-type elastic member, but may employ a push and pull feedthrough device (not shown).

The bellows-type elastic member is controlled to be compressed so as to advance, i.e., forwardly move the crucible unit 150. The linkage rod 125 connected to a distal end of the bellows-type elastic member is forwardly moved (from the left to the right or from the right to the left) by the compression of the elastic member so that the movable plate 121 on which the crucible unit 150 is seated is forwardly moved along the guide rail 122.

In order to backwardly move the crucible unit 150, similarly, the compressed bellows-type elastic member is controlled to be expanded. The linkage rod 125 connected to the distal end of the bellows-type elastic member is backwardly moved (from the right to the left or from the left to the right) by the expansion of the elastic member so that the movable plate 121 on which the crucible unit 150 is seated is backwardly moved along the guide rail 122.

The source chamber 100 as constructed above is provided in plural numbers depending on the kinds of the source material (i.e., copper, indium, gallium and selenium) to be evaporated, and the effusion nozzle unit 250 in the deposition chamber is also provided in plural numbers to conform to the number of the source chambers. Similarly, the opening and closing device 300 is provided in plural numbers to conform to the number of the source chambers.

Further, the deposition chamber unit constructed as the fast deposition system for mass production of large-area thin-film CIGS solar cells according to the first embodiment of the present invention may include a deposition section M or N consisting of four source chambers, four opening and closing devices and four effusion nozzle units, which constitute one set, in plural numbers in one deposition chamber 200′ as shown in FIG. 8.

Here, the deposition section M is shown in which the opening and closing device is shut off between the source chamber and the effusion nozzle unit to sealingly close the source chamber and the deposition chamber so that the source materials depleted in the source chambers can be re-filled in a state where the deposition chamber is maintained in a vacuum-tight state.

In addition, the deposition section N is shown in which the opening and closing device is opened between the source chamber and the effusion nozzle unit to allow the source chamber and the deposition chamber to fluidically communicate with each other so that the evaporation source materials in the source chambers can be deposited on the substrate through the effusion nozzle units in the deposition chamber.

As such, a plurality of deposition sections is included in one deposition chamber 200′ so that the source materials depleted can be re-filled as well as a fast 24-hour continuous deposition process is enabled.

Moreover, as shown in FIGS. 5(a) and 5(b), an effusion nozzle unit 250d fluidically communicating with a selenium source chamber 100d among a plurality of source chambers 100a, 100b, 100c and 100d is branched off into a plurality of effusion nozzle units, for example, two to four effusion nozzle units so that it is disposed in front of an effusion nozzle unit 250a fluidically communicating with a copper source chamber 100a and at the back of an effusion nozzle unit 250c fluidically communicating with a gallium source chamber 100c. Alternatively, the effusion nozzle unit 250d fluidically communicating with a selenium source chamber 100d is disposed in front of the effusion nozzle unit 250a fluidically communicating with the copper source chamber 100a, between the effusion nozzle unit 250a fluidically communicating with the copper source chamber 100a and an effusion nozzle unit 250b fluidically communicating with an indium source chamber 100b, between the effusion nozzle unit 250b fluidically communicating with the indium source chamber 100b and the effusion nozzle unit 250c fluidically communicating with the gallium source chamber 100c, and at the back of the effusion nozzle unit 250c fluidically communicating with the gallium source chamber 100c.

This is intended to supply a large amount of selenium source because the vaporization temperature of the selenium is lower than the heating temperature of the substrate which is approximately 500□ such that even after the deposition of source materials on the substrate, re-evaporation of the selenium source occurs, which results in a degradation in quality of the CIGS thin film.

Also, FIGS. 6 and 7 show a second embodiment of the deposition chamber unit 30 constructed as the fast deposition system for mass production of large-area thin-film CIGS solar cells according to the present invention.

Referring to FIGS. 6 and 7, the deposition chamber unit 30′ according to this embodiment includes: a deposition chamber 200; a plurality of source chambers 100′ including a moving means 120′; and a plurality of effusion nozzle units 250′. Similar to the first embodiment, a heating member H₀ is disposed at an inner lower portion of the deposition chamber 200 and the substrate 500 is transferred along a rail above the heating member H₀.

The difference between the first embodiment and the second embodiment is that the same source chambers 100′ are disposed opposed to each other at both sides of the deposition chamber 200. Also, a plurality of opening and closing devices 300 is provided at both sides of the deposition chamber 200 in a vertical direction to a process line, and a set of source chambers 100′; 100′a, 100′b, 100′c and 100′d are disposed at both sides of the deposition chamber 200, respectively, in such a fashion that the same source chambers 100′a, 100′a; 100′b, 100′b; 100′c, 100′c; 100′d, 100′d fluidically communicate with each other.

The opposed source chambers 100′ are coupled at one sides thereof to both sides of the deposition chamber 200 in such a fashion as to fluidically communicate with the deposition chamber 200 through the opening and closing devices 300. Similar to the first embodiment, each of the source chambers 100′ includes a crucible unit 150′ built therein so as to evaporate source materials. The source chamber further includes an injector 170 fixedly coupled to the crucible unit 150 in such a fashion as to fluidically communicate with the crucible unit and a moving means 120′ for forwardly and backwardly moving the crucible unit 150′.

Also, similar to the first embodiment, the crucible unit 150′ is preferably disposed inside a housing so as to facilitate maintenance and repair thereof. A heating member is provided between the outer side of the crucible unit 150 and the inner side of the housing so as to surround the crucible unit 150. A heat radiation plate 159 or a heat radiation wall is preferably provided between the outer side of the heating member H₁ and the inner side of the housing 158.

The injector 170′ is detachably engaged with the hole (not shown) formed at one side of the crucible unit 150′. The injector 170′ has a cylindrical or polygonal shape which is opened at both ends thereof, and has protrusions formed at the front and rear ends thereof. Each of the protrusion has a step formed thereon. The front end protrusion (not shown) is engaged with the hole of the crucible unit 150′, and the rear end protrusion is engaged with an engagement groove P of the effusion nozzle unit 250′ correspondingly.

In addition, similar to the first embodiment, the rear end protrusion 174′ of the injector 170′ is preferably fittingly engaged with the engagement groove P of the effusion nozzle unit 250 in such a fashion as to be slidably moved forwardly and backwardly. Here, various sealing materials (not shown) may be further provided between the end edge of the rear end protrusion 174′ of the injector 170′ and the engagement grooves P formed at both sides of the effusion nozzle unit 250′ so as to hermetically seal the coupling portion between the injector and the effusion nozzle unit.

The plurality of the effusion nozzle units 250′ is formed in a bar shape having a polygonal cross-section and an inner space of a predetermined size. One end 252′ and the other end 254′ of each effusion nozzle unit 250′ is opened so as to fluidically communicate with respective associated source chambers (for example, 100′a, 100′a; 100′b, 100′b; 100′c, 100′c; and 100′d, 100′d) coupled to both sides of the deposition chamber 200, and an engagement groove P is respectively formed at the inner circumferential edges of the one end 252′ and the other end 254′ of the each effusion nozzle unit 250. Each effusion nozzle unit 250′ includes a plurality of nozzles (not shown) longitudinally formed at a bottom surface thereof.

In addition, the plurality of effusion nozzle units 250′ is fixedly mounted at an upper portion of the deposition chamber 200 in a vertical direction to a process line. The one ends 252′ of the plurality of effusion nozzle units 250 are arranged so as to respectively correspond to the plurality of opening and closing devices 300 mounted at one side of the deposition chamber 200, and the other ends 254′ of the effusion nozzle units 250 are arranged so as to respectively correspond to the plurality of opening and closing devices 300 mounted at the other side of the deposition chamber 200.

Further, the shape of the nozzle 255 includes, but is not limited to, a cylindrical shape, a funnel shape, a sandglass shape and the like. Here, the sum of the cross-section of the inner diameter of each of the plurality of nozzles of the effusion nozzle unit 250′ preferably is smaller than the cross-section of the inner diameter of the rear end protrusion 174′ of the injector 170′.

Moreover, a heating member is preferably provided at the outer side of the effusion nozzle unit 250′ so as to prevent the evaporated source materials in the effusion nozzle unit 250′ from being condensed or adhered onto the inner wall surface of the effusion nozzle unit as well as enable the smooth downward effusion of the evaporated source materials. Similarly, a heat radiation plate or a heat insulating wall is preferably provided at the outer side of the heating member. Also, a housing is preferably provided at the outer side of the heat radiation plate so as to cover the surroundings of the heat radiation plate to prevent heat radiation out of the heat radiation plate and facilitate the maintenance and repair of the effusion nozzle unit 250. A cooling line is preferably further provided at the outer side of the housing.

In addition, preferably, the deposition chamber unit 30 further includes a shutter 290 between the effusion nozzle unit 250′ and the substrate 500 in the deposition chamber 200.

As such, a set of source chambers 100′ are provided at both sides of the deposition chamber 200, respectively, so that since two injectors 170′ are fittingly inserted into the engagement grooves formed at both ends of each effusion nozzle unit 250′, a difference in the distances between the rear end of the injector 170′ and each nozzle of the effusion nozzle unit 250′ during the deposition process is reduced, and as a consequence, the amount of the evaporated source material effused downwardly from each nozzle of the effusion nozzle unit 250′ onto the substrate is made uniform and constant.

Similar to the first embodiment, the moving means 120′ serves to forwardly and backwardly move the crucible unit 150′ in each source chamber 100′. The moving means 120′ includes a movable plate, a guide rail not shown), and a movement control device.

A bellows-type elastic member is controlled to be compressed so as to advance, i.e., forwardly move the crucible unit 150 of the source chamber. A linkage rod connected to a distal end of the bellows-type elastic member is forwardly moved by the compression of the elastic member so that the movable plates on which the crucible units 150′ are seated are forwardly moved from the left to the right and from the right to the left, respectively, in the source chambers coupled to both sides of the deposition chamber.

In order to backwardly move the crucible units 150′, similarly, the compressed bellows-type elastic member is controlled to be expanded. The linkage rod connected to the distal end of the bellows-type elastic member is backwardly moved by the expansion of the elastic member so that the movable plates on which the crucible units 150 are seated are backwardly moved from the right to the left or from the left to the right, respectively, in the source chambers coupled to both sides of the deposition chamber.

In the present invention, it has been described and shown that the forward and backward movements of the crucible units 150′ of the opposed source chambers coupled to both sides of the deposition chamber are controlled to be performed concurrently, but is not limited thereto. Alternatively, only the opening and closing device disposed at one side (right side) or the other side (left side) of the deposition chamber 200 may be opened so as to allow a set of source chambers fluidically communicating therewith to be operated alternately. In this case, it will be apparent to those skilled in the art that the end edge of the effusion nozzle unit disposed opposed to the opening and closing device can be hermetically sealed by a sealing member.

Such construction of the deposition chamber unit allows a set of source chambers provided at one side of the deposition chamber to be operated while another set of source chambers provided at the other side of the deposition chamber can be re-filled as well as enables a 24-hour continuous deposition process.

In addition, similar to the first embodiment, of course, the deposition chamber unit constructed as the fast deposition system for mass production of large-area thin-film CIGS solar cells according to the present invention may include a deposition section (not shown) consisting of eight source chambers, eight opening and closing devices and four effusion nozzle units, which constitute one set, in plural numbers in one deposition chamber.

Further, the deposition chamber unit 30 according to the first and second embodiments as constructed above may be disposed in a series (30-1,30-2,30-3) or parallel (30,30) relationship in an in-line deposition process system as shown in FIGS. 9 and 10 so as to perform the deposition process.

The deposition chamber units 30 are constructed in series so that a continuous deposition is possible as well as the total thickness of the CIGS deposition layers to be deposited on the substrate can be set in such a fashion that the deposition contents of the CIGS deposition layers are divided in the same ratio or in a predetermined ratio.

Such a deposition process minimizes the outgassing of the evaporation source materials to be deposited on the substrate so that the inner short-circuiting can be prevented, so that since the evaporated source material of each deposition chamber unit is dividedly deposited in a certain amount on the substrate and the divided deposition can be controlled, the frequency of exchanges of the source materials in the source chambers can be reduced. Thus, this construction of the deposition chamber unit is suited for the fast mass-production of large-area solar cells.

In addition, it is possible to form the CIGS layer having the desired component composition and uniform thickness on a large-area glass substrate at high speed.

Further, the deposition chamber units 30 each in which a plurality of deposition sections is included in one deposition chamber are arranged in parallel with each other so that it is possible to select any one of the deposition chamber units to perform a continuous deposition process. This parallel arrangement allows the source materials of any one of the deposition chamber units selected to be re-filled or allows the process line to be changed to perform the deposition process even without suspending the operation of the process system when requiring repair of the system, thereby enabling a continuous deposition process.

Since the deposition chamber unit according to the present invention is constructed such that the deposition chamber and the source chamber is separated from each other by the opening and closing device, it has an advantage in that the re-filling of the source materials in the source chambers can be possible in a state where the deposition chamber is maintained in a vacuum-tight state.

Moreover, since the deposition chamber unit according to the present invention includes plural sets of source chambers, the deposition chamber can be operated on a 24-hour full operation. When the plural sets of source chambers are operated, the respective sets of opening and closing devices interconnecting the deposition chamber and the source chambers can be sequentially controlled in the opening and closing operation.

It will be apparent to those skilled in the art that a separate opening and closing door (not shown) and a vacuum exhaust pump are provided at the plurality of source chambers and the deposition chamber according to the present invention

Now, a substrate deposition method using the fast deposition system for mass production of large-area thin-film CIGS solar cells according to the present invention will be described hereinafter with reference to the accompanying drawings.

First, a plurality of source chambers each including a crucible unit built therein is respectively connected to one outer side or both outer sides of a deposition chamber including a plurality of effusion nozzle units built therein by means of a plurality of opening and closing devices.

That is, a deposition section consisting of a desired number of source chambers, the opening and closing devices and the effusion nozzle units, which correspond to the source chambers, is set in plural numbers.

Thereafter, after granular metal source materials are charged in proper amounts into respective crucible units of the plurality of source chambers in the deposition section, the covers of the crucible units are closed, each injector is fixedly engaged with each of the crucible units, and each crucible unit is seated on the moveable plate.

Then, the source chambers of one-side deposition section are maintained in a high-vacuum state.

The respective opening and closing devices interconnecting the plurality of source chambers and the deposition chamber in the high-vacuum deposition section are opened, and each crucible unit is moved forwardly by using the moving means to cause the rear end of the injector to be slidably engaged with the engagement groove of each effusion nozzle unit.

Here, the rear end of the injector fixedly engaged with the crucible unit is oriented toward the effusion nozzle unit according to the forward movement of the crucible unit by the moving means, and the protrusion formed at the rear end of the injector is slidably fittingly engaged with the engagement groove of the effusion nozzle unit.

In this case, the shutter disposed below the effusion nozzle unit is held open.

Subsequently, the electric power is supplied to the heating members surrounding corresponding crucible unit and effusion nozzle unit to heat the crucible unit and the effusion nozzle unit.

The metal source material stored in the heated crucible unit is evaporated to form an evaporated source material. Then, the evaporated source material is diffusedly moved to the effusion nozzle unit along the injector.

The evaporated source material diffusedly moved to the effusion nozzle unit is effused downwardly through the plurality of nozzles and is deposited on the substrate transferred to the inner lower portion of the deposition chamber.

Here, the substrate is loaded in the loading chamber unit, and then is moved to the pre-heating chamber unit in a vacuum state along a rail so as to be heated to a proper temperature, so that it is transferred to the inside of the deposition chamber and is subjected to the deposition process in a state where a deposition preparation step has been completed. In this case, the substrate is positioned below the effusion nozzle unit in such a fashion as to be spaced apart from the effusion nozzle unit by a predetermined interval, and the evaporated source materials effused from the effusion nozzle unit are sequentially deposited on the substrate by each evaporation source.

Of course, it is required that the substrate should be maintained at a temperature ranging from approximately 500□ to 600□ by the heating member disposed below the substrate so that the evaporated source materials are smoothly deposited to a desired thickness and in a desired composition ratio on the substrate.

The substrate subjected to the deposition process in the deposition chamber unit is cooled and water-washed in the cooling chamber unit, and then is taken out to the outside through the unloading chamber unit.

In this manner, the source chamber constructed independently of the deposition chamber enables the re-filling of the source materials in a state where the high vacuum is maintained in the deposition chamber.

In addition, in order to enable a continuous deposition process by including a plurality of deposition sections one deposition chamber, the crucible units of a first deposition section M requiring the re-filling of the source material depleted are backwardly moved by using the moving means.

The rear end of the injector fixedly engaged with each crucible unit is disengaged from the engagement groove of the effusion nozzle unit according to the backward movement of the crucible unit to return to the inside of the source chamber.

In this case, the shutter is controlled to be closed which is disposed below the effusion nozzle unit fluidically communicating with the source chamber whose source material is depleted.

Then, after a corresponding opening and closing device is shut off and a high-temperature, high-vacuum state is released in the source chamber using a vacuum exhaust pump of the source chamber, a door (not shown) of the source chamber is opened to re-fill the source material depleted in the source chamber.

In this case, preferably, a set of the plurality of source chambers constructed in one deposition section are controlled to be simultaneously operated such that respective evaporated source materials are uniformly deposited on the substrate and the composition ratio of the evaporated source material components are properly adjusted.

In addition, the first deposition section M is re-filled with new source materials, and simultaneously a second deposition section N is prepared to perform the deposition process.

That is, after a granular metal source material is charged into the crucible unit of the source chamber whose source material is depleted, the opening and closing devices connected to the deposition chamber of the second deposition section N are opened and the crucible unit is forwardly moved using the moving means.

The forward movement of the crucible unit causes the rear end protrusion of the injector fixedly engaged with the crucible unit to be slidably engaged with the engagement groove of the effusion nozzle unit.

In this case, the shutter is controlled to be closed which is disposed below the effusion nozzle units fluidically communicating with the source chambers of the first deposition section M, and the shutter is controlled to be opened which is disposed below the effusion nozzle units fluidically communicating with the source chambers of the first deposition section N.

Then, similarly, the electric power is supplied to the heating members surrounding the crucible units of the second deposition section to heat the crucible units.

The crucible units are heated so that the granular metal source materials stored therein are melt to evaporate, and the evaporated source materials are diffusedly moved to the effusion nozzle units along the injectors and are effused downwardly from the effusion nozzle units through the plurality of nozzles so as to be deposited on the substrate.

In this case, the operations of the first deposition section and the second deposition section are controlled so that the time gap does not occur in the deposition process and a 24-hour continuous deposition is possible.

Moreover, preferably, the deposition chamber unit of the second embodiment as shown in FIG. 6 is controlled by a single control system such that the opposed opening and closing devices disposed at both sides of the deposition chamber are simultaneously operated. Of course, the left-side source chambers or the right-side source chambers may be constructed to constitute one set so that two sets of source chambers are alternately operated to perform the deposition process.

In the present invention, it has been described that a CIGS layer serving as a sunlight-absorbing layer of a thin-film solar cell is deposited, but the present invention is not limited thereto. It is, of course, to be noted that a solar cell module can be manufactured by using an evaporation device employing an incorporated source in the CdTe deposition process.

As described above, the fast deposition system for mass production of large-area thin-film CIGS solar cells according to the present invention as constructed above has an advantageous effect in that a CIGS layer can be deposited on a large-area substrate such that its thickness and composition are uniform.

In addition, The fast deposition system for mass production of large-area thin-film CIGS solar cells according to the present invention as constructed above has an advantageous effect in that the source materials depleted can be sequentially re-filled into the crucible in a state where a deposition chamber is maintained in a high-vacuum state in a large-area thin-film solar cell process system, making it possible to perform a continuous deposition process, and as a consequence, solar cells can be mass-produced continuously at high speed

While the present invention have been described in connection with the exemplary embodiments illustrated in the drawings, it will be appreciated that they are merely an illustrative embodiments and various equivalent modifications and variations of the embodiments can be made by a person having an ordinary skill in the art without departing from the spirit and scope of the present invention. Therefore, the appended claims also include such modifications and variations falling within the true technical scope of the present invention.

What is claimed is:

1. A fast deposition system for mass production of large-area thin-film CIGS solar cells, comprising:
a deposition chamber;
a plurality of source chambers each coupled at one side thereof to one outer side or both outer sides of the deposition chamber through an opening and closing device, each source chamber including a crucible unit adapted to evaporate a source material;
a plurality of effusion nozzle units disposed inside the deposition chamber and detachably engaged with a plurality of crucible units in such a fashion as to fluidically communicate with the crucible units, each of the effusion nozzle units including a plurality of nozzles longitudinally formed at a bottom surface thereof and having an inner space of a predetermined size; and
a moving means adapted to forwardly and backwardly move the crucible unit in each of the source chambers.

2. The fast deposition system according to claim 1, wherein the crucible unit comprises a cylindrical or polygonal box-like body which is opened at a top thereof and is closed at a bottom thereof, and a cover, the cover having a hole formed at one side thereof, or the body having a hole formed at one side of an upper portion thereof and the cover having a hole formed at one side thereof to correspond to the one side of the body.

3. The fast deposition system according to claim 2, wherein the hole formed in the crucible unit has a female thread formed on the inner circumferential surface thereof.

4. The fast deposition system according to claim 1, wherein each of the source chambers further includes an injector fixedly coupled to each crucible unit in such a fashion as to fluidically communicate with the crucible unit.

5. The fast deposition system according to claim 4, wherein the injector has a protrusion formed at a front end and a rear end thereof, respectively.

6. The fast deposition system according to claim 5, wherein the protrusion formed at the front end of the injector has a male thread formed on the outer circumferential surface thereof.

7. The fast deposition system according to claim 5, wherein the protrusion formed at the front end of the injector has a retaining step formed on the outer circumferential edge thereof.

8. The fast deposition system according to claim 1, wherein the plurality of the effusion nozzle units is formed in a bar shape having a polygonal cross-section, and has an engagement groove formed at one end thereof in such a fashion as to fluidically communicate with the plurality of source chambers, or formed at both ends thereof.

9. The fast deposition system according to claim 1, further comprising a shutter disposed below the plurality of effusion nozzle units in such a fashion as to be spaced apart from the effusion nozzle units.

10. The fast deposition system according to claim 1, wherein the moving means comprises: a movable plate on which the crucible unit is seated, a guide rail adapted to guide the movement of the movable plate, and a movement control device adapted to control the movable plate to be forwardly and backwardly moved.

11. The fast deposition system according to claim 10, wherein the movement control device comprises:
a bellows-type elastic member disposed at an outer lower portion of the source chamber;
a linkage rod adapted to interconnect the movable plate and the bellows-type elastic member; and
a controller adapted to control the operation of the linkage rod.

12. The fast deposition system according to claim 10, wherein the movement control device comprises a push and pull feedthrough device.

13. The fast deposition system according to claim 1, wherein a deposition section having a construction in which the number of the source chambers is four, the number of the opening and closing devices is four and the number of the effusion nozzle units is four, which constitute one set, is included in plural numbers in a single deposition chamber.

14. The fast deposition system according to claim 13, wherein one of the plurality of deposition sections is operated such that corresponding opening and closing devices are opened to open the source chambers and the deposition chamber so as to allow the crucible units of the source chambers and the effusion nozzle units of the deposition chamber to be engaged with each other in such a fashion as to fluidically communicate with each other so that the evaporation source materials in the source chambers are deposited on the substrate through the effusion nozzle units in the deposition chamber, and
wherein the other of the plurality of deposition sections is operated such that the crucible units of the source chambers and the effusion nozzle units of the deposition chamber are disengaged from each other and the corresponding opening and closing devices are shut off to sealingly close the source chambers and the deposition chamber so that the source materials depleted in the source chambers are re-filled in a state where the deposition chamber is maintained in a vacuum-tight state.

15. The fast deposition system according to claim 13, wherein the deposition chamber including the deposition section in plural numbers is disposed in plural numbers in a series or parallel relationship.

16. The fast deposition system according to claim 15, wherein the plurality of deposition chambers disposed in series with each other is constructed such that the total thickness of the CIGS deposition layers to be deposited on the substrate is set in such a fashion that the deposition contents of the CIGS deposition layers are divided in the same ratio or in a predetermined ratio.

17. The fast deposition system according to claim 1, wherein a heating member is provided at the outer side of each of the crucible units of the plurality of source chambers and at the outer side of each of the plurality of effusion nozzle units, and a housing is provided at the outer side of the heating member.

18. The fast deposition system according to claim 17, wherein a heat radiation plate is further provided between the outer side of the heating member and the inner side of the housing.

19. A fast deposition system for mass production of large-area thin-film CIGS solar cells, comprising:
a deposition chamber;
a plurality of source chambers each coupled at one side thereof to one outer side or both outer sides of the deposition chamber through an opening and closing device, each source chamber including a crucible unit adapted to evaporate a source material, an injector detachably fixedly coupled to the crucible unit in such a fashion as to fluidically communicate with the crucible unit, and a moving means adapted to forwardly and backwardly move the crucible unit; and
a plurality of effusion nozzle units disposed inside the deposition chamber and each formed in a bar shape having a polygonal cross-section and an inner space of a predetermined size, each effusion nozzle unit having an engagement groove formed at one end or both ends thereof so as to be detachably engaged with the injector in such a fashion as to fluidically communicate with the crucible unit, and a plurality of nozzles longitudinally formed at a bottom surface thereof.

20. The fast deposition system according to claim 19, wherein the moving means comprises: a movable plate on which the crucible unit is seated, a guide rail adapted to guide the movement of the movable plate, and a movement control device adapted to control the movable plate to be forwardly and backwardly moved.

21. The fast deposition system according to claim 20, wherein the movement control device comprises: a bellows-type elastic member disposed at an outer lower portion of the source chamber; a linkage rod adapted to interconnect the movable plate and the bellows-type elastic member; and a controller adapted to control the operation of the linkage rod.

22. The fast deposition system according to claim 19, wherein a heating member is provided at the outer side of each crucible unit of the plurality of source chambers and at the outer side of each of the plurality of effusion nozzle units, a heat radiation plate is provided at the outer side of the heating member, and a housing is provided at the outer side of the heat radiation plate.

23. A fast deposition method for mass production of large-area thin-film CIGS solar cells, comprising the steps of:
allowing a plurality of source chambers each including a crucible unit built therein to be respectively connected to one outer side or both outer sides of a deposition chamber including a plurality of effusion nozzle units built therein by means of a plurality of opening and closing devices;
allowing granular metal source materials to be charged in proper amounts into respective crucible units of the plurality of source chambers in the deposition section, closing the covers of the crucible units, fixedly engaging each injector with each of the crucible units, and placing each crucible unit on a moveable plate;
allowing the source chambers to be maintained in a high-vacuum state;
opening the respective opening and closing devices interconnecting the plurality of source chambers and the deposition chamber, and forwardly moving each crucible unit by using a moving means to cause the rear end of the injector to be slidably engaged with an engagement groove of each effusion nozzle unit;
supplying the electric power to heating members surrounding the crucible unit and the effusion nozzle unit to heat the crucible unit and the effusion nozzle unit.
allowing the metal source material stored in the heated crucible unit to be evaporated to form an evaporated source material and allowing the evaporated source material to be diffusedly moved to the effusion nozzle unit along the injector; and
allowing the evaporated source material diffusedly moved to the effusion nozzle unit to be effused downwardly through a plurality of nozzles and to be deposited on the substrate transferred to the inner lower portion of the deposition chamber.

24. The fast deposition method according to claim 23, wherein a deposition section having a construction in which the number of the source chambers is four, the number of the opening and closing devices is four and the number of the effusion nozzle units is four, which constitute one set, is included in plural numbers in a single deposition chamber.

25. The fast deposition method according to claim 24, wherein one of the plurality of deposition sections is operated such that corresponding opening and closing devices are opened to open the source chambers and the deposition chamber so as to allow the crucible units of the source chambers and the effusion nozzle units of the deposition chamber to be engaged with each other in such a fashion as to fluidically communicate with each other so that the evaporation source materials in the source chambers are deposited on the substrate through the effusion nozzle units in the deposition chamber, and
wherein the other of the plurality of deposition sections is operated such that the crucible units of the source chambers and the effusion nozzle units of the deposition chamber are disengaged from each other and the corresponding opening and closing devices are shut off to sealingly close the source chambers and the deposition chamber so that the source materials depleted in the source chambers are re-filled in a state where the deposition chamber is maintained in a vacuum-tight state, thereby enabling a continuous deposition process.

26. The fast deposition method according to claim 24, wherein the deposition chamber including the deposition section in plural numbers is disposed in plural numbers in a series or parallel relationship.

27. The fast deposition method according to claim 26, wherein the plurality of deposition chambers disposed in series with each other is constructed such that the total thickness of the CIGS deposition layers to be deposited on the substrate is set in such a fashion that the deposition contents of the CIGS deposition layers are divided in the same ratio or in a predetermined ratio.

28. The fast deposition method according to claim 26, wherein the plurality of deposition chambers disposed in parallel with each other is constructed such that any one of the deposition chambers is selected to perform a continuous deposition process.
